(19) United States
(12) Patent Application Publication
(10) Pub. No.: US 2026/0133683 A1
(43) Pub. Date: May 14, 2026

(54) CONTROL METHOD, CONTROL DEVICE, AND ELECTRONIC APPARATUS

(71) Applicant: Lenovo (Beijing) Limited, Beijing (CN)

(72) Inventors: Xiaofeng ZHU, Beijing (CN); Sanjay DHAR, Chicago, IL (US)

(21) Appl. No.: 19/365,676

(22) Filed: Oct. 22, 2025

(30) Foreign Application Priority Data
Nov. 13, 2024 (CN) 202411616506.5

(51) Int. Cl. G06F 3/04845; G06F 1/16; G06F 3/04817; G06F 3/0488

(52) U.S. Cl. CPC G06F 3/04845; G06F 1/1652; G06F 3/04817; G06F 3/0488

(57) ABSTRACT

A control method includes displaying a first object and a second object and, in response to a moving operation on the first object controlling the first object to move to a target position located within a response area of the second object, controlling a display device to change from a first deformation state to a second deformation state. A first displayable area of the display device in the first deformation state is different from a second displayable area of the display device in the second deformation state.

### CROSS-REFERENCE TO RELATED APPLICATION

This application claims priority to Chinese Application No. 202411616506.5, filed on November 13, 2024, the entire content of which is incorporated herein by reference.

### TECHNICAL FIELD

The present disclosure generally relates to the field of computer technologies and, more particularly, to a control method, a control device, and an electronic apparatus.

### BACKGROUND

With the development of science and technology, flexible displays are gradually being used in more and more electronic apparatuses. Flexible displays can bend, be curved, and have multiple deformation states. Existing methods for controlling the deformation of flexible displays include manual control by users, control through function buttons of specific applications, and control by detecting the motion states of electronic apparatuses. Currently, deformation control methods for flexible displays are still relatively limited.

### SUMMARY

In accordance with the present disclosure, there is provided a control method including displaying a first object and a second object and, in response to a moving operation on the first object controlling the first object to move to a target position located within a response area of the second object, controlling a display device to change from a first deformation state to a second deformation state. A first displayable area of the display device in the first deformation state is different from a second displayable area of the display device in the second deformation state.

Also in accordance with the present disclosure, there is provided a control device including a display module and a control module. The display module is configured to display a first object and a second object. The control module is configured to, in response to a moving operation on the first object controlling the first object to move to a target position located within a response area of the second object, controlling a display device to change from a first deformation state to a second deformation state. A first displayable area of the display device in the first deformation state is different from a second displayable area of the display device in the second deformation state.

Also in accordance with the present disclosure, there is provided an electronic apparatus including a deformable device and a control device. The control device is configured to control the display device to display a first object and a second object and, in response to a moving operation on the first object controlling the first object to move to a target position located within a response area of the second object, control the display device to change from a first deformation state to a second deformation state. A first displayable area of the display device in the first deformation state is different from a second displayable area of the display device in the second deformation state.

### BRIEF DESCRIPTION OF THE DRAWINGS

FIG. 1 is a flowchart of a control method consistent with the present disclosure.

FIG. 2 is a schematic structural diagram of a display device of an electronic apparatus consistent with the present disclosure.

FIG. 3 is another flowchart of a control method consistent with the present disclosure.

FIG. 4 is a schematic diagram of an application scenario of a control method consistent with the present disclosure.

FIG. 5 is another flowchart of a control method consistent with the present disclosure.

FIG. 6 is a schematic structure diagram of a control device consistent with the present disclosure.

FIG. 7 is a schematic structure diagram of an electronic apparatus consistent with the present disclosure.

FIG. 8 is a composition structural diagram of an electronic apparatus consistent with the present disclosure.

### DETAILED DESCRIPTION OF THE EMBODIMENTS

Specific embodiments of the present disclosure are hereinafter described with reference to the accompanying drawings. The described embodiments are merely examples of the present disclosure, which may be implemented in various ways. Specific structural and functional details described herein are not intended to limit, but merely serve as a basis for the claims and a representative basis for teaching one skilled in the art to variously employ the present disclosure in substantially any suitable detailed structure. Various modifications may be made to the embodiments of the present disclosure. Thus, the described embodiments should not be regarded as limiting, but are merely examples. Those skilled in the art will envision other modifications within the scope and spirit of the present disclosure.

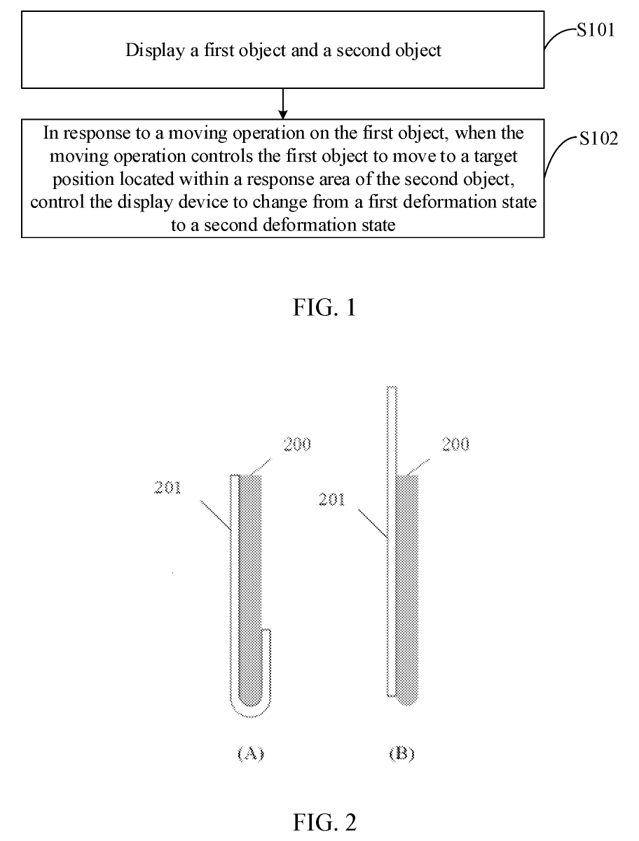

The present disclosure provides a control method. As shown in FIG. 1, in one embodiment, the control method includes:

S101: displaying a first object and a second object; and

S102, in response to a moving operation on the first object, when a target position to which the moving operation controls the first object to move is located within a response area of the second object, controlling a display device to change from a first deformation state to a second deformation state.

A first displayable area of the display device under the first deformation state may be different from a second displayable area of the display device under the second deformation state.

The control method provided by the present disclosure may be applied to an electronic apparatus including a deformable display device, and the electronic apparatus may be a smartphone, a laptop computer, a tablet computer, etc. including a flexible display screen, or other electronic apparatuses including a deformable display device. A deformation mode may be any mode that is able to change the shape of the display device, such as curling deformation or bending deformation. The display device may include at least two deformation states, and the displayable areas of the display device under different deformation states may be different.

In S101, the type of the first object and the type of the second object may be the same or different. For example, in one embodiment, the first object may be an interface or icon of an application, and the second object may be a function button. In another embodiment, the first object may be a function button, and the second object may be an interface or icon of an application. In another embodiment, the first object may be an icon or interface of a first application, and the second object may be an icon or interface of a second application.

In one embodiment, displaying the first object and the second object may include displaying the first object and the second object synchronously. For example, when the first object and the second object are both deployed on the desktop, the first object and the second object may be displayed synchronously. In another embodiment, one of the first object or the second object may be displayed first, and then another one of the second object or the first object may be displayed after responding to the operation on the first object/the second object, such that the first object and the second object are displayed simultaneously in the displayable area of the display device. For example, when the first object is the interface of the application and is displayed in full-screen mode, in response to the long press operation on the edge area of the interface, the first object may be set to a non-full-screen movable state, and the second object may be displayed in the displayable area.

In one embodiment, in S102, in response to the moving operation on the first object, when the moving operation controls the first object to move to the target position located in the response area of the second object, the display device may be controlled to change from the first deformation state to the second deformation state. The moving operation on the first object may be a user’s drag operation on the first object. The second object may include one or more response areas. The first deformation state may be a current state of the display device, and the second deformation state may be a state after the display device is deformed. The first displayable area of the display device in the first deformation state may be different from the second displayable area of the display device in the second deformation state. The first displayable area and the second displayable area may be different in size, different in position, or both different in size and position.

In one embodiment, as shown in FIG. 2, the electronic apparatus may further include a body 200, and the deformable display device may be a flexible display screen 201 that is curled and attached along both sides of the body of the electronic apparatus. The first deformation state may be a state in which the flexible display screen 201 is flush with the body 200 of the electronic apparatus, as shown in part (A) of FIG. 2, and the second deformation state may be a state in which the flexible display screen 201 exceeds the body 200 of the electronic apparatus and the flexible display screen 201 is fully unfolded, as shown in part (B) of FIG. 2, or a state in which the flexible display screen 201 exceeds the body 200 of the electronic apparatus but is not fully unfolded (not shown in the figure). Alternatively, in another embodiment, the first deformation state may be a state in which the flexible display screen 201 exceeds the body 200 of the electronic apparatus, and the second deformation state may be a state in which the flexible display screen 201 is flush with the body 200 of the electronic apparatus. The first displayable area of the display device in the first deformation state may be different in size from the second displayable area of the display device in the second deformation state.

In another embodiment, the electronic apparatus may further include a body, and the deformable display device may be a single-sided scroll-type flexible display screen including an extended portion attached along one side of the body of the electronic apparatus and a curled portion retracted in a roll at the bottom of the body of the electronic apparatus. The first deformation state may be a state in which the extended portion is flush with the body of the electronic apparatus. The second deformation state may be a state in which the extended portion exceeds the body of the electronic apparatus. Or, the first deformation state may be a state in which the extended portion exceeds the body of the electronic apparatus, and the second deformation state may be a state in which the extended portion is flush with the body of the electronic apparatus. The first displayable area of the display device in the first deformation state is different in size from the second displayable area of the display device in the second deformation state.

In yet another embodiment, the electronic apparatus may further include a first body and a second body capable of relative rotation with respect to each other, and a first display device located at a first surface of the first body. The first display device may be a straight screen that cannot be deformed. The deformable second display device may be a bendable flexible display screen, located at a second surface of the first body and a third surface of the second body. The second surface may be connected to the third surface. The first deformation state may be a state in which the first body and the second body overlap, and the first displayable area may be the display area of the first display device. The second deformation state may be a state in which the first body and the second body may be unfolded, and the second displayable area may be the display area of the second display device. Or, the first deformation state may be a state in which the first body and the second body may be unfolded, and the first displayable area may be the display area of the second display device; the second deformation state may be a state in which the first body and the second body overlap, and the second displayable area may be the display area of the first display device.

In the present disclosure, the first deformation state may be any deformation state of the display device, and the second deformation state may be any deformation state of the display device other than the first deformation state. For example, when the first deformation state is a contracted state in which the display device is flush with the body of the electronic apparatus body, the second deformation state may be an extended state in which the display device exceeds the body of the electronic apparatus body. The displayable area of the display device may be enlarged when the first deformation state changes to the second deformation state. As another example, when the first deformation state is the extended state, the second deformation state may be the contracted state, and the displayable area of the display device may be reduced when the first deformation state changes to the second deformation state.

In the present disclosure, by displaying the first object and the second object, the moving operation on the first object may be responded. When the moving operation controls the first object to move to the target position within the response area of the second object, the display device may be controlled to change from the first deformation state to the second deformation state, thereby achieving control of the deformation of the display device according to the interaction of different display objects, and enriching the control method of the deformable display device.

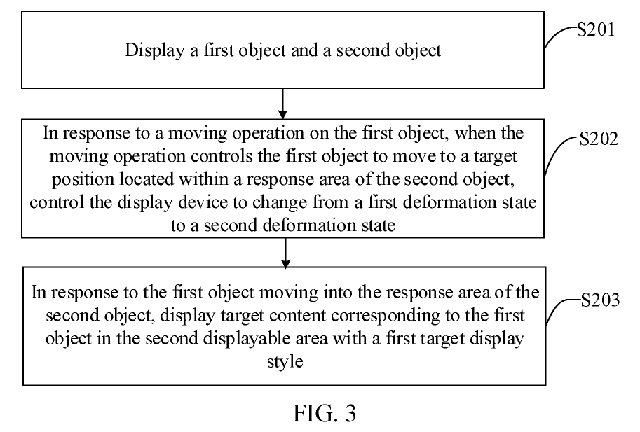

In another embodiment, as shown in FIG. 3, the control method includes:

S201, displaying the first object and the second object;

S202, in response to the moving operation on the first object, when the moving operation controls the first object to move to the target position within the response area of the second object, controlling the display device to change from the first deformation state to the second deformation state; and

S203, in response to the first object moving into the response area of the second object, displaying target content corresponding to the first object in the second displayable area in a first target display style.

S201 may be similar to S101, and S202 may be similar to S102, description of which will not be repeated here.

In 203, when the user moves the first object to the response area of the second object, in addition to triggering the change in the shape of the display device, a change in the display of the display device may also be triggered. The content to be displayed by the display device may be the target content corresponding to the first object, and the target content may be the same as the first object, or related to the first object; and the first target display style may be determined according to the second object.

In one embodiment, the second object may be any one of a group of function buttons for indicating the display style of the application, and the first target display style may be the display style corresponding to the second object. The first target display style may include one or more of the display layout (display position, position relationship), relative display size, display color, display skin, display style, font, etc.

For example, the second object may be a function button used to indicate the relative display size and display layout of the application. In the current first deformation state, when the first object is the icon of the application, the first object and the second object may be synchronously displayed on the desktop. In response to the user moving the first object to the response area of the second object indicating the first display size and the first display layout, such as “3/4 screen-centered,” the display device may be controlled to switch from the first deformation state to the second deformation state, the default interface of the application may be determined to be the target content of the first object, and the default interface of the application may be displayed in the second displayable area with the first display size and the first display layout, that is, a display size of 3/4 screen and a centered layout.

For example, the second object may be a function button for indicating the display skin of an application. In the current first deformation state, when the first object is the interface of the application, in response to the user’s long press operation on the edge area of the application interface, the first object may be set in a movable state, the optional display skin of the application may be loaded to generate multiple second objects and displayed, and the button style of the second object may be a thumbnail of the corresponding display skin. In response to the user moving the first object to the response area of the second object indicating the first optional display skin, the display device may be controlled to switch from the first deformation state to the second deformation state, the interface of the application may be determined to be the target content of the first object, and the interface of the application may be displayed in the second displayable area in the style of the first optional display skin. It should be understood that with the change of the deformation state of the display device, the relative display size of the interface of the application may not change, and the physical display size may change. In one embodiment, the display range of the first object may remain unchanged, and the display ratio may be adaptively adjusted according to the change of the displayable area. In another embodiment, the display range of the first object may be adaptively adjusted according to the change of the displayable area, that is, the amount of display content of the first object may change with the change of the size of the displayable area.

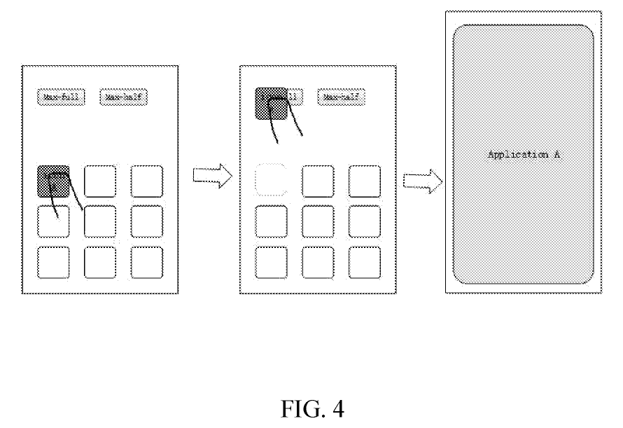

In an application scenario of the embodiments of the present disclosure, for example, as shown in FIG. 4, in the first deformation state, the size of the first displayable area may be small, and the first object and the second object may be displayed. The first object may be an application icon, such as Icon A (the icon of the application A), and the second object may be a function button for indicating the deformation state and the display layout of the application, such as “Max-full” (maximizing the displayable area, full-screen display of the application interface). In response to the first object, when the target position to which the first object is moved by the moving operation is located in the response area of the second object, the display device may be controlled to change from the first deformation state to the second deformation state, and the size of the second displayable area may be the largest. In the second displayable area, the interface of the application A may be displayed in full-screen.

In another embodiment, the second object may be any one of a group of function buttons for controlling the running state of the application, and the running state may include run-show (run and display), run-in-background (background running, no interface may be displayed), exit (the program may be completely closed), etc. When the second object corresponds to run-show, the display style may be further specified. When the second object corresponds to run-in-background or exit, the target content may be the default display interface of the electronic apparatus, such as a mobile phone desktop, and the first target display style may be the default display style of the default display interface.

For example, when the first deformation state is the extended state of the display device, the first object may be the interface of the application B, and the second object may correspond to a first running state, such as exit. In response to the user moving the first object into the response area of the second object indicating the first running state, the display device may be controlled to switch from the first deformation state to the second deformation state, that is, the contracted state. The running of application B may be terminated, and the default display interface of the electronic apparatus may be displayed in the second displayable area in a default manner (generally full-screen).

In one embodiment, the response area of the second object may include a first response area and a second response area. The first target display style may include a first display style and a second display style, and the first display style may be different from the second display style.

In S203, in response to the first object moving into the response area of the second object, displaying the target content corresponding to the first object in the second displayable area using the first target display style may include:

when the first object moves to the first response area, in response to the first object moving into the response area of the second object, displaying the target content corresponding to the first object in the second displayable area with the first display style; and

when the first object moves to the second response area, in response to the first object moving into the response area of the second object, displaying the target content corresponding to the first object in the second displayable area with the second display style.

In this embodiment, the second object may be a set of function buttons for indicating the display style of the application, and the second object may include a first response area, a second response area, and may also include more response areas, and the number of response areas of the second object may be the same as the number of elements in the set of function buttons. The first response area may correspond to the first element in the set, and the first element may indicate the first display style. The second response area may correspond to the second element in the set, and the second element may indicate the second display style; and so on. The second object may include multiple response areas, each corresponding to one display style. According to the response area of the second object to which the first object moves, the target content of the first object may be displayed in the second displayable area with one display style corresponding to the response area.

The display style may include one or more of display layout (display position, position relationship), display size, display color, display skin, display style, font, etc.

For example, the second object may be a set of function buttons used to indicate the display style of the application. In the current first deformation state, when the first object is the icon of the application, the first object and the second object may be synchronously displayed on the desktop. In response to the user moving the first object to one response area in the second object indicating the first display style, such as a simple style, the display device may be controlled to switch from the first deformation state to the second deformation state, the interface of the application may be determined to be the target content of the first object, and the interface of the application may be displayed with the first display style in the second displayable area.

In one embodiment of the present disclosure, the target content may be the interface or default interface of the first application; the first object may be the interface or icon of the first application; and the second object may be the interface or icon of the second application.

The default interface may be the default display interface of the electronic apparatus, such as a mobile phone desktop, a computer desktop, etc. When the first object is the interface of the first application, the target content corresponding to the first object may be the interface of the first application, or the default interface of the electronic apparatus. When the first object is the icon of the first application, the target content of the first object may be the interface of the first application. The second object may be the interface or icon of the second application.

In one embodiment, the second application may have a different type from the first application, and the first application may be any application that is able to independently implement functions, such as a camera application, a shopping application, a video playback application, a financial application, etc., and the second application may be an application that is used to assist or control other applications and cannot independently implement functions.

For example, multiple function buttons for controlling the running state of other applications may be encapsulated together to obtain the second application. The first deformation state may be an extended state of the display device, and the first object may be the interface of the application C. In response to the user moving the first object to the response area indicating the first running state, such as run-in-background (background running, no interface displayed) in the second object, the display device may be controlled to switch from the first deformation state to the second deformation state, that is, the contracted state; the application C may be suspended in the background, and the default interface of the electronic apparatus may be displayed in the second displayable area in a default manner (generally full-screen).

As another example, multiple function buttons for indicating the display style of other applications may be encapsulated together to obtain the second application. When the second object is the interface of the second application, since the second application plays an auxiliary role, the interface of the second application may be displayed in the state of a side frame or a sidebar by default, that is, the second object may be a side frame or a sidebar. The second object may include multiple response areas, each of which may correspond to one display style. In response to the user moving the first object to the first response area indicating the first display style in the second object, the target content corresponding to the first object may be displayed with the first display style in the second displayable area.

When the second object is an icon of the second application, the second object may include a third response area in the first stage and a fourth response area in the second stage. The fourth response area may be a collection of function buttons that control the display styles of other applications, and the fourth response area may include multiple response sub-areas. In response to the moving operation for the first object, the first object may be controlled to move to a stop position (the first object may not be released at this time) located in the third response area of the second object, and the fourth response area of the second object may be displayed. In response to the moving operation for the first object, the first object may be controlled to move to a target position (the position where the first object may be released) located in the response area and indicating the first display style in the fourth response area of the second object, and the target content corresponding to the first object may be displayed in the second displayable area with the first display style.

In another embodiment, the second application may be of the same type as the first application, and both may be applications that may independently realize functions. For example, the first object may be an icon or interface of the first application, and the second object may be an interface of the second application. The first object and the second object may be displayed, and in response to the first object moving into the response area of the second object, the interface of the first application may be displayed in the second displayable area with the display style of a floating window.

The second object may be divided into multiple response areas, for example, four response areas corresponding to the upper left, lower left, upper right, and lower right respectively. In response to the first object moving into the response area indicating “lower left” in the second object, the interface of the first application may be displayed in the lower left display area of the second displayable area as a floating window.

For example, the first object may be an icon or interface of the first application, and the second object may be an icon of the second application. The first object and the second object may be displayed. In response to the first object moving into the response area of the second object, the interface of the first application may be displayed in half screen in the second displayable area.

The second object may be divided into multiple response areas, for example, four response areas corresponding to the upper left, lower left, upper right, and lower right respectively. In response to the first object moving into the response area indicating “right” in the second object, the interface of the first application may be displayed in the right half screen in the second displayable area.

In one embodiment, the control method may further include:

in response to the first object moving into the response area of the second object, displaying the target content corresponding to the second object in the second displayable area with a second target display style; or

in response to the first object moving into the response area of the second object, displaying the target content corresponding to the first object and the target content corresponding to the second object in the second displayable area with a third target display style.

In one embodiment, the content to be displayed by the display device may be the target content corresponding to the second object, and the target content may be the same as the second object, or related to the second object. The second target display style may be determined according to the first object. For example, the first object may be any one of a group of function buttons indicating the display style of the application, and the second target display style may be the display style corresponding to the first object. The second target display style may include one or more of display layout (display position, position relationship), relative display size, display color, display skin, display style, font, etc. As another example, the first object may be any one of a group of function buttons for controlling the running state of the application, the target content may be the default interface of the electronic apparatus, such as the mobile phone desktop, and the second target display style may be the default display style of the default interface.

For example, the first object may be a function button used to indicate the relative display size and display layout of an application. In the current first deformation state, when the second object is the icon of the application, the first object and the second object may be synchronously displayed on the desktop. In response to the user moving the first object indicating the first display size and the first display layout, such as “1/4 screen-upper right,” to the response area of the second object, the display device may be controlled to switch from the first deformation state to the second deformation state. The interface of the application may be determined to be the target content of the second object, and the interface of the application may be displayed in the second displayable area with the first display size and the first display layout, that is, the display size of 1/4 screen and the layout of the upper right corner.

In another embodiment, the content to be displayed by the display device may be the target content corresponding to the first object and the target content corresponding to the second object, and the target content may be the same as the corresponding object or may be related to the corresponding object. For example, the third target display style may be determined according to the first object. For example, when the first object is the interface of the first application and the second object is the interface or icon of the second application, in response to the first object moving into the response area of the second object, the interface of the second application may be displayed in the full-screen mode in the second displayable area, and the interface of the first application may be displayed in the interface of the second application in a floating window.

As another example, when the first object is the icon of the first application and the second object is the interface or icon of the second application, in response to the first object moving into the response area of the second object, the interface of the first application may be displayed in the second displayable area in a split-screen manner.

In another example, the third target display style may be determined according to the second object. For example, when the first object is the interface or icon of the first application and the second object is the interface of the second application, in response to the first object moving into the response area of the second object, the interface of the second application may be displayed in the full-screen mode in the second displayable area, and the interface of the first application may be displayed in the interface of the second application in a floating window.

For example, when the first object may be the interface or icon of the first application and the second object may be the icon of a second application, in response to the first object moving into the response area of the second object, the interface of the first application and the interface of the second application may be displayed in a split-screen manner in the second display area.

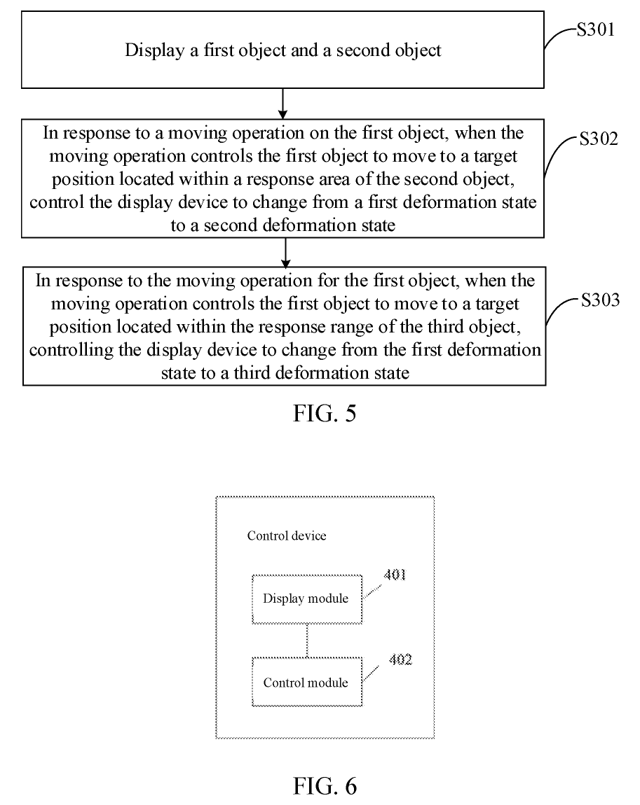

In another embodiment shown in FIG. 5, the control method may include:

S301, displaying a first object, a second object, and a third object;

S302, in response to a moving operation for the first object, when the moving operation controls the first object to move to a target position located within a response area of the second object, controlling the display device to change from a first deformation state to a second deformation state; and

S303, in response to the moving operation for the first object, when the moving operation controls the first object to move to a target position located within the response range of the third object, controlling the display device to change from the first deformation state to a third deformation state.

The first displayable area of the display device in the first deformation state, the second displayable area of the display device in the second deformation state, and the third displayable area of the display device in the third deformation state may be different from each other.

In the present embodiment, the display device may include three deformation states, and the displayable areas of the display device may be different in the three deformation states. For example, as shown in FIG. 2, the three deformation states may include: a contracted state in which the flexible display screen may be flush with the body of the electronic apparatus, an intermediate state in which the flexible display screen exceeds the body of the electronic apparatus but may not be fully unfolded, and a fully unfolded state in which the flexible display screen may be fully unfolded. The first deformation state may be the current deformation state. For the other two states except the first deformation state, the second object may correspond to one of the deformation states, and the third object may correspond to the other deformation state. For example, when the first deformation state is the contracted state, the first object, the second object, and the third object may be displayed; and in response to the first object moving into the response area of the second object, the display device may be controlled to change from the contracted state to the intermediate state. Or in response to the first object moving into the response area of the third object, the display device may be controlled to change from the contracted state to the fully extended state. When the first deformation state is the contracted state, the second object may correspond to the fully extended state, and the third object may correspond to the intermediate state.

In one embodiment, in S101, displaying the first object and the second object may include: displaying first content, where the first content includes the first object and the second object.

The control method may also include:

in response to the first object moving into the response area of the second object, displaying second content, where the first content includes the second content or the second content includes the first content.

The first object and the second object may both be display elements in the display screen. The first object may be a display element that may be manipulated by the user, and the second object may be a display element that cannot be manipulated by the user. For example, in a maze game, the first object may be a player character manipulated by the user, and the second object may be a game element that cannot be manipulated by the user, such as an obstacle or a gold coin.

The first content may be the display screen content of the display device in the first deformation state, and the second content may be the display screen content of the display device in the second deformation state. In an optional embodiment, the first content may include the second content, that is, the amount of information in the first content may be larger than the amount of information in the second content.

In one example shown in FIG. 2, when the first deformation state is the fully expanded state of the flexible display screen in part (B) of FIG. 2, the first content may be displayed. The maze display range of the first content may be large, and the game difficulty may be relatively low. When the user operates the player character to move to the response range of the obstacle, the game penalty may be triggered, and the display device may switch to the second deformation state, that is, the state in which the flexible display screen in part (A) of FIG. 2 is flush with the body of the electronic apparatus, such that the second content is displayed, the display range of the maze is reduced, and the game difficulty increases.

In another embodiment, the second content may include the first content, that is, the amount of information in the second content may be larger than the amount of information in the first content.

In another example shown in FIG. 2, when the first deformation state is the state in which the flexible display screen in part (A) of FIG. 2 is flush with the body of the electronic apparatus, the first content may be displayed. The maze display range of the first content may be small, and the game difficulty may be relatively high. When the user operates the player character to move to the response range of the obstacle, the game penalty may be triggered, and the display device may switch to the second deformation state, that is, the fully expanded state of the flexible display screen in part (B) of FIG. 2, such that the second content is displayed, the display range of the maze is expanded, and the game difficulty is reduced.

In the present disclosure, the change of the state of the display device may be combined with a game, to effectively increase the fun of the game.

The present disclosure also provides a control device, as shown in FIG. 6, including:

a display module 401, configured to display a first object and a second object; and

a control module 402, configured to respond to a moving operation on the first object, and, when the moving operation controls the first object to move to a target position located within a response area of the second object, control the display device to change from a first deformation state to a second deformation state.

A first displayable area of the display device in the first deformation state may be different from a second displayable area of the display device in the second deformation state.

In the present disclosure, by displaying the first object and the second object, the moving operation on the first object may be responded. When the moving operation controls the first object to move to the target position within the response area of the second object, the display device may be controlled to change from the first deformation state to the second deformation state, thereby achieving control of the deformation of the display device according to the interaction of different display objects, and enriching the control method of the deformable display device.

In some embodiments, the display module 401 may be also configured to: in response to the first object moving into the response area of the second object, display target content corresponding to the first object in the second displayable area with a first target display style.

In some embodiments, the response area of the second object may include a first response area and a second response area. The first target display style may include a first display style and a second display style, where the first display style is different from the second display style;

The display module 401 may be also configured to:

when the first object moves into the first response area, in response to the first object moving into the response area of the second object, display the target content corresponding to the first object in the second displayable area with the first display style; and

when the first object moves into the second response area, in response to the first object moving into the response area of the second object, display the target content corresponding to the first object in the second displayable area with the second display style.

In some embodiments, the target content may be an interface of the first application or a default interface. The first object may be an interface or an icon of the first application, and the second object may be an interface or an icon of the second application.

In some embodiments, the display module 401 may be also configured to:

in response to the first object moving into the response area of the second object, displaying the target content corresponding to the second object in the second displayable area with the second target display style; or

in response to the first object moving into the response area of the second object, display the target content corresponding to the first object and the target content corresponding to the second object are displayed in the second displayable area with the third target display style.

In some embodiments, the display module 401 may be also used to display a third object; and the control module 402 may be also used to: respond to the moving operation on the first object, and, when the moving operation controls the first object to move to the target position within the response range of the third object, control the display device to change from the first deformation state to the third deformation state.

The first displayable area of the display device in the first deformation state, the second displayable area of the display device in the second deformation state, and the third displayable area of the display device in the third deformation state may be different from each other.

In some embodiments, the display module 401 may also be configured to: display a first content, where the first content includes the first object and the second object.

And the display module 401 may also be used to: display a second content in response to the first object moving into the response area of the second object, where the first content includes the second content or the second content includes the first content.

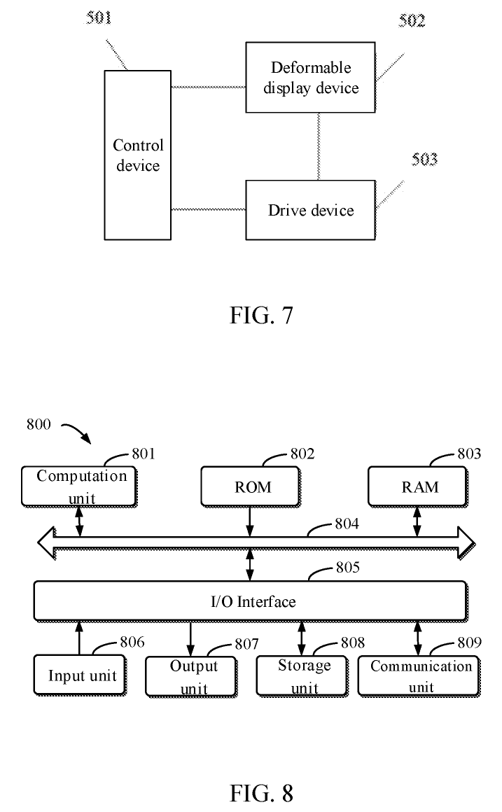

The present disclosure also provides an electronic apparatus. In one embodiment shown in FIG. 7 which is a structural diagram of an electronic apparatus, the electronic apparatus includes:

a deformable display device 501, configured to display a first object and a second object; and

a control device 502, configured to: respond to a moving operation on the first object, and, when the moving operation controls the first object to move to a target position located within a response area of the second object, control the display device to change from a first deformation state to a second deformation state.

A first displayable area of the display device in the first deformation state may be different from a second displayable area of the display device in the second deformation state.

In one embodiment, the electronic apparatus may further include:

a drive device 503, which is used to receive a driving instruction of the control device, and drive the deformable display device to change from a first deformation state to a second deformation state in response to the driving instruction.

The present disclosure also provides an electronic apparatus and a readable storage medium.

FIG. 8 shows a schematic block diagram of an example electronic apparatus 800 that may be used to implement any embodiment of the present disclosure. The electronic apparatus is intended to represent various states of digital computers, such as laptop computers, desktop computers, workstations, personal digital assistants, servers, blade servers, mainframe computers, or other suitable computers. The electronic apparatus may also represent various states of mobile devices, such as personal digital processing, cellular phones, smart phones, wearable devices or other similar computing devices. The components shown herein, their connections and relationships, and their functions are merely examples and are not intended to limit the implementation of the present disclosure described and/or required herein.

As shown in FIG. 8, in one embodiment, the device 800 may include a computation unit 801. The computation unit 801 may perform various appropriate actions and processes according to a computer program stored in a read-only memory (ROM) 802 or a computer program loaded from a storage unit 808 into a random access memory (RAM) 803. The RAM 803 may be also used to store various programs and data required for the operation of the device 800. The computation unit 801, the ROM 802, and the RAM 803 may be connected to each other through a bus 804. An input/output (I/O) interface 805 may also be connected to the bus 804.

Multiple components in the device 800, including: an input unit 806 (such as a keyboard, a mouse, etc.), an output unit 807 (such as various types of displays, speakers, etc.), a storage unit 808 (such as a disk, an optical disk, etc., or a communication unit 809 (such as a network card, a modem, a wireless communication transceiver, etc.) may be connected to the I/O interface 805 The communication unit 809 may enable the device 800 to exchange information/data with other devices through a computer network such as the Internet and/or various telecommunication networks.

The computation unit 801 may be a variety of general and/or special processing components with processing and computing capabilities. Some examples of the computation unit 801 include, but are not limited to, a central processing unit (CPU), a graphics processing unit (GPU), various dedicated artificial intelligence (AI) computing chips, various computation units running machine learning model algorithms, digital signal processors (DSPs), or any appropriate processors, controllers, microcontrollers, etc. The computation unit 801 may be able to perform the various methods and processes described above, such as the control method. For example, in some embodiments, the control method provided by various embodiments of the present disclosure may be implemented as a computer software program which is tangibly contained in a machine-readable medium, such as the storage unit 808. In some embodiments, part or all of the computer program may be loaded and/or installed on the device 800 via the ROM 802 and/or the communication unit 809. When the computer program is loaded into the RAM 803 and executed by the computation unit 801, part or all of the control method provided by various embodiments of the present disclosure may be performed. In some other embodiments, the computation unit 801 may be configured to perform the control method in any other appropriate manner (e.g., by means of firmware).

Various embodiments of the systems and techniques described above herein may be implemented in digital electronic circuit systems, integrated circuit systems, field programmable gate arrays (FPGAs), application specific integrated circuits (ASICs), application specific standard products (ASSPs), systems on chips (SOCs), complex programmable logic devices (CPLDs), computer hardware, firmware, software, and/or any combinations thereof. For example, they may be implemented in one or more computer programs. The one or more computer programs may be executed and/or interpreted on a programmable system including at least one programmable processor. One programmable processor may be a dedicated or general programmable processor, and may receive data and instructions from a storage system, at least one input device, or at least one output device, and transmit data and instructions to the storage system, the at least one input device, or the at least one output device.

The program code for implementing the method disclosed herein may be written in any combination of one or more programming languages. These program codes may be provided to a processor or controller of a general-purpose computer, a dedicated computer, or other programmable data processing device, such that the program code, when executed by the processor or controller, enables the functions/operations specified in the flow chart and/or block diagram to be implemented. The program code may be executed entirely on the machine, partially on the machine, partially on the machine as an independent software package and partially on a remote machine or entirely on a remote machine or server.

In the present disclosure, a machine-readable medium may be a tangible medium that may contain or store a program for use by or in conjunction with an instruction execution system, device or equipment. The machine-readable medium may be a machine-readable signal medium or a machine-readable storage medium. The machine-readable medium may include, but is not limited to, electronic, magnetic, optical, electromagnetic, infrared, or semiconductor systems, devices or equipment, or any suitable combination thereof. A more specific example of a machine-readable storage medium may include an electrical connection based on one or more lines, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

To provide interaction with a user, the systems and techniques described herein may be implemented on a computer including a display device (e.g., a flexible OLED (organic light emitting diode)) for displaying information to the user and a keyboard and a pointing device (e.g., a mouse or trackball) through which the user can provide input to the computer. Other types of devices can also be used to provide interaction with the user; for example, the feedback provided to the user can be any state of sensory feedback (e.g., visual feedback, auditory feedback, or tactile feedback); and input from the user can be received in any state (including acoustic input, voice input, or tactile input).

The systems and techniques described herein may be implemented in a computing system including a backend component (e.g., as a data server), or a computing system including a middleware component (e.g., an application server), or a computing system including a frontend component (e.g., a user computer with a graphical user interface or a web browser through which a user can interact with an implementation of the systems and techniques described herein), or a computing system including any combination of such backend components, middleware components, or frontend components. The components of the system may be interconnected by digital data communication (e.g., a communication network) in any state or medium. Examples of communication networks include: a local area network (LAN), a wide area network (WAN), or the Internet.

A computer system may include a client and a server. The client and server may generally be remote from each other and typically interact through a communication network. The client and server relationship may be generated by computer programs running on respective computers and having a client-server relationship with each other. The server may be a cloud server, a server of a distributed system, or a server incorporating a blockchain.

It should be understood that the various states of the process shown above may be used to reorder, add, or delete steps. For example, the steps described in the present disclosure may be executed in parallel, sequentially, or in different orders, as long as the expected results of the technical solutions disclosed in the present disclosure can be achieved, and this document does not limit this.

It should also be noted that the terms “first\second\third” involved in the embodiments of the present disclosure are only used to distinguish similar objects and do not represent a specific ordering or number of the objects. It is understandable that “first\second\third” may be interchanged in a specific order or sequence where permitted, so that the embodiments of the present disclosure described herein can be implemented in an order other than that illustrated or described herein. In the present disclosure, “multiple” may mean two or more, unless specified otherwise.

Various embodiments have been described to illustrate the operation principles and exemplary implementations. It should be understood by those skilled in the art that the present disclosure is not limited to the specific embodiments described herein and that various other obvious changes, rearrangements, and substitutions will occur to those skilled in the art without departing from the scope of the present disclosure. Thus, while the present disclosure has been described in detail with reference to the above described embodiments, the present disclosure is not limited to the above described embodiments, but may be embodied in other equivalent states without departing from the scope of the present disclosure.

What is claimed is:

1. A control method comprising:
displaying a first object and a second object; and
in response to a moving operation on the first object controlling the first object to move to a target position located within a response area of the second object, controlling a display device to change from a first deformation state to a second deformation state;
wherein a first displayable area of the display device in the first deformation state is different from a second displayable area of the display device in the second deformation state.

2. The method according to claim 1, further comprising:
in response to the first object moving into the response area of the second object, displaying target content corresponding to the first object in the second displayable area with a target display style.

3. The method according to claim 2, wherein:
the response area of the second object includes a first response area and a second response area;
the target display style includes a first display style and a second display style different from the first display style; and
in response to the first object moving into the response area of the second object, displaying the target content in the second displayable area with the target display style includes:
in response to the first object moving into the first response area, displaying the target content in the second displayable area with the first display style; or
in response to the first object moving into the second response area, displaying the target content in the second displayable area with the second display style.

4. The method according to claim 2, wherein:
the target content includes an interface of a first application or a default interface;
the first object includes the interface of the first application or an icon of the first application; and
the second object includes an interface of a second application or an icon of the second application.

5. The method according to claim 1, further comprising:
in response to the first object moving into the response area of the second object, displaying target content corresponding to the second object in the second displayable area with a target display style.

6. The method according to claim 1, further comprising:
in response to the first object moving into the response area of the second object, displaying target content corresponding to the first object and target content corresponding to the second object in the second displayable area with a target display style.

7. The method according to claim 1, further comprising:
displaying a third object; and
in response to the moving operation on the first object controlling the first object to move to a target position within a response range of the third object, controlling the display device to change from the first deformation state to a third deformation state;
wherein the first displayable area of the display device in the first deformation state, the second displayable area of the display device in the second deformation state, and a third displayable area of the display device in the third deformation state are different from each other.

8. The method according to claim 1,
wherein displaying the first object and the second object includes displaying first content that includes the first object and the second object;
the method further comprising:
displaying second content in response to the first object moving into the response area of the second object;
wherein the first content includes the second content or the second content includes the first content.

9. A control device comprising:
a display module configured to display a first object and a second object; and
a control module configured to, in response to a moving operation on the first object controlling the first object to move to a target position located within a response area of the second object, controlling a display device to change from a first deformation state to a second deformation state;
wherein a first displayable area of the display device in the first deformation state is different from a second displayable area of the display device in the second deformation state.

10. An electronic apparatus comprising:
a deformable display device; and
a control device configured to:
control the display device to display a first object and a second object; and
in response to a moving operation on the first object controlling the first object to move to a target position located within a response area of the second object, control the display device to change from a first deformation state to a second deformation state;
wherein a first displayable area of the display device in the first deformation state is different from a second displayable area of the display device in the second deformation state.

11. The device according to claim 10, further comprising:
a drive device configured to receive a driving instruction from the control device, and drive the deformable display device to change from the first deformation state to the second deformation state in response to the driving instruction.

12. The device according to claim 10, wherein the control device is further configured to:
in response to the first object moving into the response area of the second object, control the display device to display target content corresponding to the first object in the second displayable area with a target display style.

13. The device according to claim 12, wherein:
the response area of the second object includes a first response area and a second response area;
the target display style includes a first display style and a second display style different from the first display style; and
the control device is further configured to, when controlling the display device to display the target content in the second displayable area with the target display style in response to the first object moving into the response area of the second object:
in response to the first object moving into the first response area, control the display device to display the target content in the second displayable area with the first display style; or
in response to the first object moving into the second response area, control the display device to display the target content in the second displayable area with the second display style.

14. The device according to claim 12, wherein:
the target content includes an interface of a first application or a default interface;
the first object includes the interface of the first application or an icon of the first application; and
the second object includes an interface of a second application or an icon of the second application.

15. The device according to claim 10, wherein the control device is further configured to:
in response to the first object moving into the response area of the second object, control the display device to display target content corresponding to the second object in the second displayable area with a target display style.

16. The device according to claim 10, wherein the control device is further configured to:
in response to the first object moving into the response area of the second object, control the display device to display target content corresponding to the first object and target content corresponding to the second object in the second displayable area with a target display style.

17. The device according to claim 10, wherein:
the control device is further configured to:
control display device to display a third object; and
in response to the moving operation on the first object to control the first object to move to a target position within a response range of the third object, control the display device to change from the first deformation state to a third deformation state; and
the first displayable area of the display device in the first deformation state, the second displayable area of the display device in the second deformation state, and a third displayable area of the display device in the third deformation state are different from each other.

18. The device according to claim 10, wherein:
the first object and the second object are included in first content;
the control device is further configured to control the display device to display second content in response to the first object moving into the response area of the second object; and
the first content includes the second content or the second content includes the first content.
